(19) United States
(12) Patent Application Publication
(10) Pub. No.: US 2023/0281593 A1
(43) Pub. Date: Sep. 7, 2023

(54) ELECTRONIC RECEIPT SYSTEM, RECEIPT PROCESSING DEVICE, RECEIPT PROCESSING METHOD, AND PROGRAM STORAGE MEDIUM

(71) Applicant: Toshiba Tec Kabushiki Kaisha, Tokyo (JP)

(72) Inventors: Yasuhiro ARAI, Mishima Shizuoka (JP); Toru OGAWA, Izunokuni Shizuoka (JP)

(21) Appl. No.: 18/317,424

(22) Filed: May 15, 2023

Related U.S. Application Data
(63) Continuation of application No. PCT/JP2021/045127, filed on Dec. 8, 2021.

(30) Foreign Application Priority Data
Jan. 26, 2021 (JP) 2021-010115

(51) Int. Cl. G06Q 20/20

(52) U.S. Cl. CPC G06Q 20/209

(57) ABSTRACT

A receipt processing device includes a determination unit, a digitization unit, and a transmission unit. The determination unit is configured to determine whether receipt data generated by a receipt generation unit is receipt data of a transaction receipt indicating contents of a commercial transaction or receipt data of a non-transaction receipt indicating contents of a non-commercial transaction. The digitization unit is configured to digitize, if the receipt data is receipt data of the transaction receipt, the receipt data with an addition of first classification information and digitize, if the receipt data is receipt data of the non-transaction receipt, the receipt data with an addition of second classification information different from the first classification information. The transmission unit is configured to transmit the receipt data digitized by the digitization unit to a server.

### CROSS-REFERENCE TO RELATED APPLICATIONS

This application is a Continuation application of PCT Application No. PCT/JP2021/045127, filed Dec. 8, 2021 and based upon and claiming the benefit of priority from Japanese Patent Application No. 2021-010115, filed Jan. 26, 2021, the entire contents of all of which are incorporated herein by reference.

### FIELD

Embodiments described herein relate generally to an electronic receipt system, a receipt processing device, a receipt processing method, and a program recording medium.

### BACKGROUND

An electronic receipt service in which a receipt is digitized and a service user such as a shopper can view the receipt via a portable terminal or the like is known. The receipt data provided by a conventional electronic receipt service is a transaction receipt indicating contents of a commercial transaction settled by an accounting machine such as a point-of-sales (POS) terminal.

The receipt includes, in addition to the transaction receipt, a non-transaction receipt indicating contents of a non-commercial transaction. For example, a reload receipt in which a reload amount or the like is recorded when electronic money is reloaded, a reservation receipt in which reservation contents are recorded when a commercial product is reserved, or the like correspond to the non-transaction receipt. Conventionally, this type of non-transaction receipt is not a target of digitization.

### BRIEF DESCRIPTION OF THE DRAWINGS

FIG. 1 is a schematic configuration diagram of an electronic receipt system according to an embodiment.

FIG. 2 is a block diagram showing a main circuit configuration of a POS terminal.

FIG. 3 is a block diagram showing main functional configurations of the POS terminal.

FIG. 4 is a block diagram showing a main circuit configuration of a center server.

FIG. 5 is a schematic diagram showing a main data structure of first electronic receipt data.

FIG. 6 is a schematic diagram showing a main data structure of second electronic receipt data.

FIG. 7 is a flowchart showing a procedure of main information processing executed by a processor of the POS terminal according to a control program.

FIG. 8 is a flowchart showing a procedure of main information processing executed by a processor of the center server according to a control program.

FIG. 9 is a flowchart showing a procedure of main information processing executed by the processor of the center server according to the control program.

FIG. 10 is a schematic diagram showing an example of a top screen in a receipt list image.

FIG. 11 is a schematic diagram showing an example of a receipt selection screen in a receipt list image.

FIG. 12 is a schematic diagram showing an example of a receipt selection screen in a receipt list image.

FIG. 13 is a schematic diagram showing an example of a receipt detail image for a reservation receipt.

FIG. 14 is a schematic diagram showing an example of a receipt detail image for a reservation receipt.

FIG. 15 is a schematic diagram showing an example of a receipt detail image for a reservation receipt.

### DETAILED DESCRIPTION

In one embodiment, a receipt processing device includes a determination unit, a digitization unit, and a transmission unit. The determination unit determines whether receipt data generated by a receipt generation unit is receipt data of a transaction receipt indicating contents of a commercial transaction or receipt data of a non-transaction receipt indicating contents of a non-commercial transaction. If the receipt data is receipt data of a transaction receipt, the digitization unit digitizes the receipt data with the addition of first classification information and, and if the receipt data is receipt data of a non-transaction receipt, the digitization unit digitizes the receipt data with the addition of second classification information different from the first classification information. The transmission unit transmits the receipt data digitized by the digitization unit to a server.

Hereinafter, an embodiment will be described with reference to the drawings.

The present embodiment exemplifies an electronic receipt system which digitizes a reload receipt and a reservation receipt as a non-transaction receipt indicating contents of a non-commercial transaction in addition to a transaction receipt indicating contents of a commercial transaction settled by a point-of-sales (POS) terminal.

### <Explanation of Electronic Receipt System>

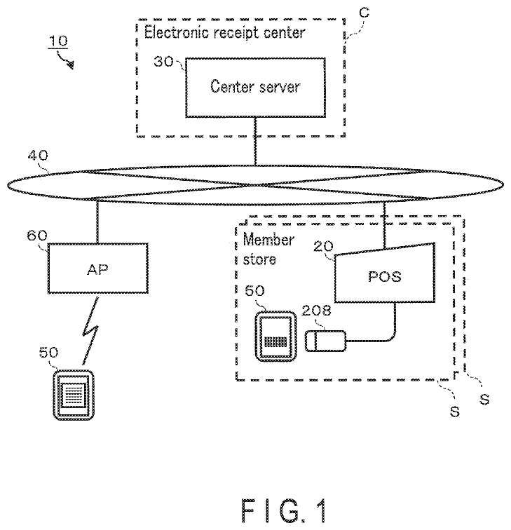

FIG. 1 is a schematic configuration diagram of an electronic receipt system 10 according to the present embodiment. The electronic receipt system 10 includes a POS terminal 20 provided in each member store S, a center server 30 provided in an electronic receipt center C, and a communication network 40. The member store S is a store which is registered as a member store in order to use the electronic receipt system 10. The electronic receipt center C is a computer center managed by an operating body that operates the electronic receipt system 10. The communication network 40 is, for example, the Internet. The POS terminal 20 of each member store S and the center server 30 of the electronic receipt center C are connected to the communication network 40 through a communication device such as a router.

In order for a service user (hereinafter, simply referred to as a user) who uses the electronic receipt service to use the electronic receipt system 10, an information terminal 50 is required. The information terminal 50 is a portable electronic device capable of performing wireless communication using a wireless local area network (LAN) or a technology of mobile communication. A large number of access points 60 conforming to the wireless LAN or mobile communication are connected to the communication network 40. The information terminal 50 performs wireless communication with the center server 30 via any one of the access points 60. As such an information terminal 50, for example, a smartphone, a tablet terminal, a mobile phone, or the like can be applied.

The user installs a dedicated application program on the information terminal 50 and applies for a membership of an electronic receipt member. Through the membership registration, a unique member ID is issued to the user. After the member ID is issued, a bar code representing the member ID is displayed on a display device of the information terminal 50 by activating the application program. Then, the user presents the bar code of the member ID displayed on the display device, for example, when the user does some shopping in the member store S and offers a settlement of the shopping to a salesperson in charge of accounting. The salesperson reads the bar code of the member ID using a bar-code reading scanner 208 provided in the POS terminal 20.

If the bar code of the member ID is read by the scanner 208, the POS terminal 20 recognizes that the commercial transaction is a transaction in which a receipt is issued not as a paper receipt but as an electronic receipt. Then, the POS terminal 20 transmits electronic receipt data obtained by digitizing a transaction receipt indicating contents of the commercial transaction to the center server 30 together with the member ID acquired from the bar code.

The center server 30 stores the electronic receipt data received from each POS terminal 20 in association with the member ID. Thereafter, upon receipt of a viewing command for viewing the electronic receipt data including the member ID from the information terminal 50, the center server 30 transmits the electronic receipt data associated with the member ID to the information terminal 50, which is a command transmission source. In the information terminal 50 which receives the electronic receipt data, a receipt image is displayed on the display device based on the electronic receipt data. Thus, the user can receive, as an electronic receipt, a receipt that is not received at the time of settlement in the member store.

The electronic receipt system 10 according to the present embodiment digitizes not only the transaction receipt described above but also a non-transaction receipt such as a reload receipt or a reservation receipt. The reload receipt is a non-transaction receipt in which information related to reloading of electronic money, such as a reload amount and a balance after reloading, is recorded when electronic money is reloaded via the POS terminal 20. The reservation receipt is a non-transaction receipt in which information related to a commercial product reservation, such as a product name, a reservation date, a scheduled receiving date, a name of a reservation person, and contact information, is recorded when the purchase of a commercial product is reserved via the POS terminal 20.

### <Explanation of POS Terminal>

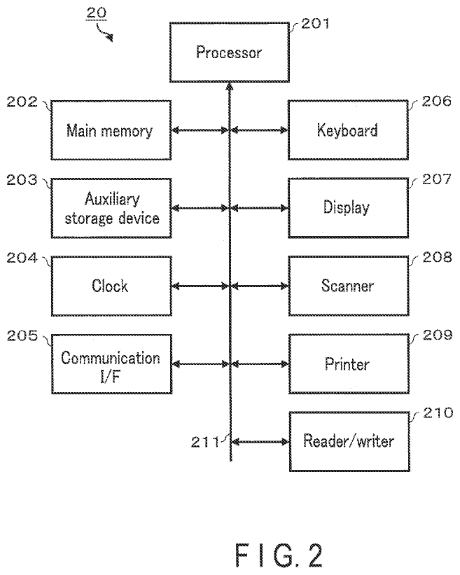

FIG. 2 is a block diagram showing a main circuit configuration of the POS terminal 20. The POS terminal 20 includes a processor 201, a main memory 202, an auxiliary storage device 203, a clock 204, a communication interface 205, a keyboard 206, a display 207, a scanner 208, a printer 209, a reader/writer 210, and a system bus 211. In the POS terminal 20, the processor 201, the main memory 202, the auxiliary storage device 203, the clock 204, the communication interface 205, the keyboard 206, the display 207, the scanner 208, the printer 209, and the reader/writer 210 are connected to the system bus 211 directly or via a signal input/output circuit. Thus, the POS terminal 20 constitutes a computer composed of the processor 201, the main memory 202, and the auxiliary storage device 203, and the system bus 211 connecting these components.

The processor 201 corresponds to a central portion of the computer. The processor 201 controls the respective components to implement various functions as the POS terminal 20 in accordance with an operating system, an application program, and the like. The processor 201 may be a processing circuit, for example, a central processing unit (CPU), a graphics processing unit (GPU), an application specific integrated circuit (ASIC), or a programmable logic device (e.g., a simple programmable logic device (SPLD), a complex programmable logic device (CPLD), a field programmable gate array (FPGA), or the like). The processor 201 is not necessarily limited to a single processing circuit, but may be configured as the processor 201 by a combination of a plurality of processing circuits.

The main memory 202 corresponds to a main storage portion of the computer mentioned above. The main memory 202 includes a non-volatile memory region and a volatile memory region. The main memory 202 stores an operating system and programs such an application program in a non-volatile memory region. In addition, the main memory 202 may store data necessary for the processor 201 to execute processes for controlling the respective components in the non-volatile or volatile memory region. The main memory 202 uses the volatile memory region as a work area in which data is rewritten by the processor 201 as appropriate. The non-volatile memory region is, for example, a read only memory (ROM). The volatile memory region is, for example, a random access memory (RAM).

The auxiliary storage device 203 corresponds to an auxiliary storage portion of the computer. For example, an electric erasable programmable read-only memory (EEPROM), a hard disc drive (HDD), a solid state drive (SSD), or the like is used as the auxiliary storage device 203. The auxiliary storage device 203 stores data to be used by the processor 201 in a case of performing various processes, or data generated by the processes performed by the processor 201. In some cases, the auxiliary storage device 203 may store the application program mentioned above.

The clock 204 functions as a time information source of the POS terminal 20. The processor 201 clocks the current date and time based on the time information clocked by the clock 204.

The communication interface 205 performs data communication with a store server or the like in a store via a local area network (LAN). The communication interface 205 is connected to the communication network 40 via a router connected to the LAN, and performs data communication with the center server 30 via the communication network 40 in accordance with a predetermined communication protocol.

The keyboard 206 is provided with various keys necessary for the POS terminal 20, such as a numeric keypad, a subtotal key, a closing key, a reload key, a reservation key, etc., and receives input of various instructions from an operator. The closing key is a key for declaring a settlement service of the commercial transaction. The reload key is a key for declaring a reload service of electronic money. The reservation key is a key for declaring a purchase reservation service of a commercial product. The keyboard 206 functions as an input device of the POS terminal 20. Instead of the keyboard 206 or in combination with the keyboard 206, a touch panel may be used as an input device. The operator is typically a salesperson in charge of accounting. However, the shopper may be the operator by himself/herself.

The display 207 displays various screens for notifying the operator of various kinds of information. The display 207 functions as a display device of the POS terminal 20. The number of displays 207 is not limited to one. For example, the POS terminal 20 may include two displays 207 for a salesperson in the store and for a shopper.

The scanner 208 optically scans and reads a bar code. The scanner 208 functions as an input device of the POS terminal 20. Each commercial product is provided with a bar code representing a commercial product code that is unique thereto. The scanner 208 can read a bar code attached to each commercial product. As described above, if the bar code of the member ID indicating the member ID is displayed on the display device of the information terminal 50, the scanner 208 can read the bar code. The scanner 208 may read a code symbol other than the bar code, for example, a two-dimensional data code.

The printer 209 prints a receipt image on a receipt paper sheet and issues a paper receipt. The printer 209 may print data on a sheet other than the receipt paper sheet, for example, a journal sheet. The printer 209 functions as a printing device of the POS terminal 20.

The reader/writer 210 has a function of subtracting electronic money from an electronic money medium and a function of reloading electronic money to the electronic money medium. The electronic money medium is, for example, an IC card, a smartphone, or the like.

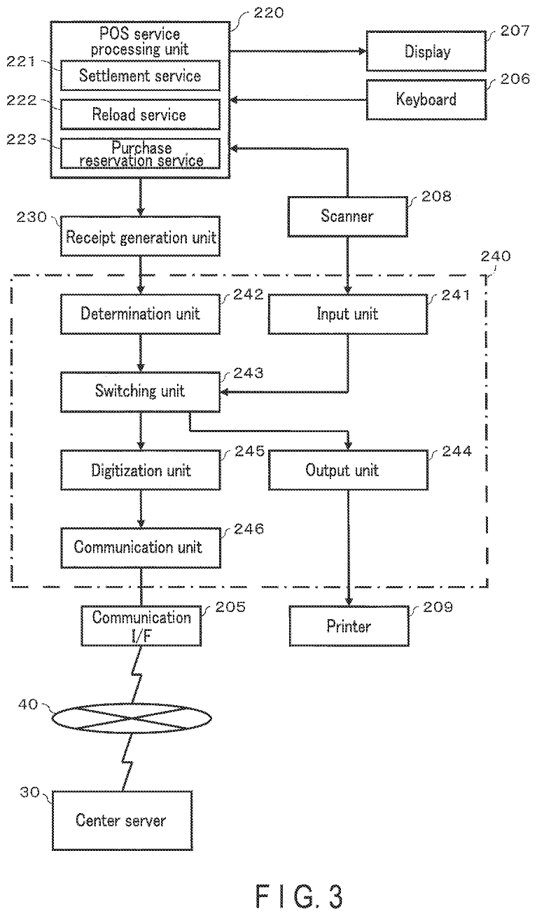

FIG. 3 is a block diagram showing main functional configurations of the POS terminal 20. The POS terminal 20 functions as a POS service processing unit 220, a receipt generation unit 230, and a receipt processing unit 240. These functions are implemented by the processor 201 performing information processing in accordance with a control program installed on the main memory 202 or the auxiliary storage device 203. The POS terminal 20 can be a receipt processing device by having a function as the receipt processing unit 240.

A method of installing the control program on the main memory 202 or the auxiliary storage device 203 is not particularly limited. The control program may be recorded in a removable recording medium or distributed through communications via the communication network, so that the control program can be installed on the main memory 202 or the auxiliary storage device 203. The recording medium may be of any type, such as a CD-ROM or a memory card, as long as it can store programs and can be read by a device.

The POS service processing unit 220 is a function that processes various services that can be executed by the POS terminal 20, such as a commercial transaction settlement service 221, an electronic money reload service 222, and a commercial product purchase reservation service 223. The settlement service 221 is a service of settling a payment for a commercial product registered via an input device such as the scanner 208 or the keyboard 206 by a payment method such as cash, a credit card, or electronic money. The reload service 222 is a service of reloading an electronic money medium with electronic money. The purchase reservation service 223 is a service of accepting a reservation for a subject commercial product and registering information necessary for the reservation.

The receipt generation unit 230 is a function of generating a receipt related to the service processed by the POS service processing unit 220. That is, the receipt generation unit 230 generates a transaction receipt for the settlement service, generates a reload receipt for the reload service, and generates a reservation receipt for the purchase reservation service. The data of the receipt generated by the receipt generation unit 230 is data in an unstructured format to be printed on a receipt paper sheet by the printer 209.

The receipt processing unit 240 has functions as an input unit 241, a determination unit 242, a switching unit 243, an output unit 244, a digitization unit 245, and a communication unit 246.

The input unit 241 inputs, as data for requesting an electronic receipt, data output from the scanner 208 that scans a bar code indicating a member ID unique to a user who uses the electronic receipt service. The input unit 241 supplies the data input from the scanner 208, that is, the member ID, to the switching unit 243.

The determination unit 242 determines whether the receipt data generated by the receipt generation unit 230 is data of a transaction receipt (first receipt) indicating contents of a commercial transaction or data of a non-transaction receipt (second receipt) indicating contents of a non-commercial transaction. The determination unit 242 supplies the determination result to the switching unit 243.

If data for requesting the electronic receipt, that is, the member ID, is input through the input unit 241, the switching unit 243 supplies the receipt data determined by the determination unit 242 to the digitization unit 245. If the member ID is not input, the switching unit 243 supplies the receipt data determined by the determination unit 242 to the output unit 244.

The output unit 244 outputs the receipt data to the printer 209. As a result, a receipt based on the receipt data is printed on a receipt paper sheet and issued as a paper receipt.

If the receipt data is data of a transaction receipt, the digitization unit 245 digitizes the receipt data with an addition of first classification information. If the receipt data is data of a non-transaction receipt, the digitization unit 245 digitizes the receipt data with an addition of second classification information different from the first classification information. Digitization refers to conversion of receipt data in an unstructured format to be printed on a receipt paper sheet into receipt data in a structured format such as a comma-separated values (CSV) format, an extensible markup language (XML) format, or a JavaScript (registered trademark) object notation (JSON) format.

The first classification information and the second classification information are not particularly limited. For example, the first classification information is set to “10”, and the second classification information is set to “11” and “12”. In short, any information may be used as long as the center server 30 can recognize that the receipt data with the first classification information is data of a transaction receipt and the receipt data with the second classification information is data of a non-transaction receipt.

The communication unit 246 transmits the receipt data digitized by the digitization unit 245 to the center server 30 via the communication network 40 connected to the communication interface 205.

### <Explanation of Center Server>

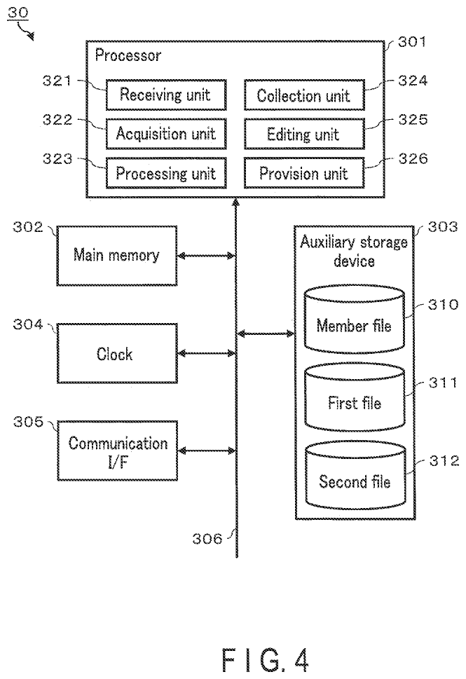

FIG. 4 is a block diagram showing a main circuit configuration of the center server 30. The center server 30 includes a processor 301, a main memory 302, an auxiliary storage device 303, a clock 304, a communication interface 305, and a system bus 306. In the center server 30, the processor 301, the main memory 302, the auxiliary storage device 303, the clock 304, and the communication interface 305 are connected to the system bus 306 directly or via a signal input/output circuit. Thus, the center server 30 constitutes a computer composed of the processor 301, the main memory 302, and the auxiliary storage device 303, and the system bus 306 connecting these components.

The processor 301 corresponds to a central portion of the computer. The processor 301 controls the respective components to implement various functions as the center server 30 in accordance with an operating system, an application program, or the like. The processor 301 may be, for example, a processing circuit, such as a CPU, a GPU, an application specific integrated circuit (ASIC), or a programmable logic device. The processor 301 is not necessarily limited to a single processing circuit, but may be configured as the processor 301 by a combination of a plurality of processing circuits.

The main memory 302 corresponds to a main storage portion of the computer mentioned above. The main memory 302 includes a non-volatile memory region and a volatile memory region. The main memory 302 stores an operating system and programs such as an application program in a non-volatile memory region. In addition, the main memory 302 may store data necessary for the processor 301 to execute processes for controlling the respective components in the non-volatile or volatile memory region. The main memory 302 uses the volatile memory region as a work area in which data is rewritten by the processor 301 as appropriate. The non-volatile memory region is, for example a ROM. The volatile memory region is, for example a RAM.

The auxiliary storage device 303 corresponds to an auxiliary storage portion of the computer. For example, an EEPROM, an HDD, an SSD, or the like is used as the auxiliary storage device 303. The auxiliary storage device 303 stores data to be used by the processor 301 in a case of performing various processes, or data generated by the processes performed by the processor 301. In some cases, the auxiliary storage device 303 may store the application program mentioned above.

The clock 304 functions as a time information source of the center server 30. The processor 301 clocks the current date and time based on the time information clocked by the clock 304.

The communication interface 305 is connected to the communication network 40, and performs data communication with an external device via the communication network 40 in accordance with a predetermined communication protocol. The external device is, for example, the POS terminal 20 of each member store S. The external device may be the information terminal 50 carried by the user.

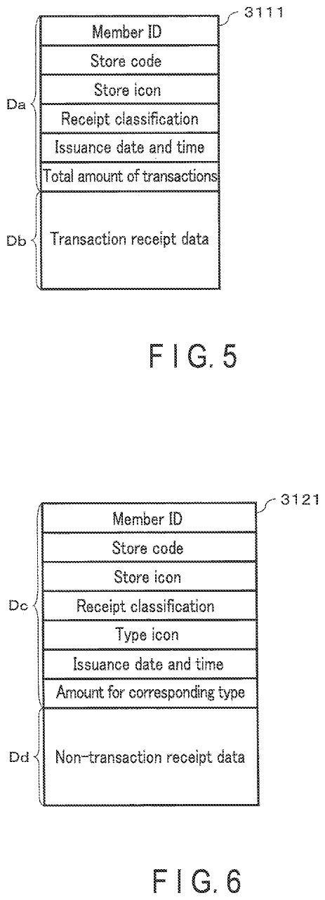

The center server 30 having such a configuration as described above includes a member file 310, a first file 311, and a second file 312 in the auxiliary storage device 303. The member file 310 stores member data including the member ID of each user registered as a member of the electronic receipt service. The first file 311 stores first electronic receipt data 3111 (see FIG. 5) generated from data of a digitized transaction receipt. The second file 312 stores second electronic receipt data 3121 (see FIG. 6) generated from data of a digitized non-transaction receipt.

FIG. 5 is a schematic diagram showing a main data structure of the first electronic receipt data 3111. As shown in FIG. 5, the first electronic receipt data 3111 includes index data Da and transaction receipt data db. The index data Da is data serving as a heading of the transaction receipt data db.

The index data Da includes a member ID, a store code, a store icon, a receipt classification, an issuance date and time, and a transaction total amount. The member ID is an identification code of a user who uses the electronic receipt service. The store code is an identification code of a store using the electronic receipt service. The store icon is an icon representing a store identified by the store code. The receipt classification is classification information indicating the transaction receipt, that is, first classification information. The issuance date and time is the date and time of issuance of the transaction receipt. The transaction total amount is the total amount of the commercial transactions indicated in the transaction receipt. The index data Da is not limited to the above-described items. Other items may be included, or some of the items may be omitted.

The transaction receipt data db is data obtained by digitizing data to be printed on a transaction receipt in a structured format. That is, in the transaction receipt data, the product name, the price, the number of sold items, the sales amount, the total number of sold items, the total amount, the payment amount, and the like are digitized in a structured format. In the information terminal 50 in which the transaction receipt data db is downloaded, it is possible to display an image of the transaction receipt based on the transaction receipt data db on the display device.

As described above, the first file 311 is an area for sequentially storing, as the first electronic receipt data 3111, the data of the transaction receipt that the user identified by the member code requested to receive as the electronic receipt in association with the member code.

FIG. 6 is a schematic diagram showing a main data structure of the second electronic receipt data 3121. As shown in FIG. 6, the second electronic receipt data 3121 includes index data Dc and non-transaction receipt data Dd. The index data Dc is data serving as a heading of the non-transaction receipt data Dd.

The index data Dc includes a member ID, a store code, a store icon, a receipt classification, a type icon, an issuance date and time, and an amount for the corresponding type. The member ID, the store code, and the store icon are the same as those of the first electronic receipt data 3111.

The receipt classification is classification information indicating a non-transaction receipt, that is, second classification information. The second classification information is different from the first classification information. The second classification information includes reload classification information indicating a reload receipt and reservation classification information indicating a reservation receipt. As described above, if the second classification information is set to “11” and “12”, it is assumed that the reload classification information is set to “11” and the reservation classification information is set to “12”.

The type icon is an icon capable of identifying the type of the non-transaction receipt. Therefore, in the present embodiment, the type icon is a reload icon representing a reload receipt or a reservation icon representing a reservation receipt. That is, if the receipt classification is the reload classification information, the type icon is the reload icon. If the receipt classification is the reservation classification information, the type icon is the reservation icon.

The issuance date and time is the date and time of an issuance of the non-transaction receipt. The amount for the corresponding type is an amount indicated on the non-transaction receipt. In a case of a reload receipt, the amount for the corresponding type is a reload amount. In a case of a reservation receipt, the amount for the corresponding type is an amount of the reserved commercial product. The index data Dc is not limited to the above-described items. Other items may be included, or some of the items may be omitted.

The non-transaction receipt data Dd is data obtained by digitizing data to be printed on a non-transaction receipt in a structured format. In a case of a reload receipt, the data is obtained by digitizing the reload amount and the balance after reloading in a structured format. In a case of a reservation receipt, the data is obtained by digitizing a product name, a reservation date and time, a scheduled receiving date, a name of a reservation person, contact information, and the like in a structured format. In the information terminal 50 in which the non-transaction receipt data Dd is downloaded, it is possible to display an image of the non-transaction receipt based on the non-transaction receipt data Dd on the display device.

As described above, the second file 312 is an area for sequentially storing, as the second electronic receipt data 3121, the data of the non-transaction receipt that the user identified by the member code requested to receive as the electronic receipt in association with the member code.

Explanations will return to FIG. 4.

In the center server 30, the processor 301 is configured to function as a receiving unit 321, an acquisition unit 322, a processing unit 323, a collection unit 324, an editing unit 325, and a provision unit 326. These functions are implemented by the processor 301 performing information processing in accordance with a control program installed on the main memory 302 and the auxiliary storage device 303.

A method of installing the control program on the main memory 302 or the auxiliary storage device 303 is not particularly limited. The control program may be recorded in a removable recording medium or distributed through communications via the communication network, so that the control program can be installed on the main memory 302 or the auxiliary storage device 303. The recording medium may be of any type, such as a CD-ROM or a memory card, as long as it can store programs and can be read by a device.

The receiving unit 321 has a function of receiving the receipt data digitized by the receipt processing unit 240 of the POS terminal 20 via the communication interface 305.

The acquisition unit 322 has a function of acquiring the classification information added to the receipt data received by the receiving unit 321, that is, the first classification information or the second classification information.

The processing unit 323 has a function of processing the receipt data received by the receiving unit 321 as the receipt data of the transaction receipt if the classification information acquired by the acquisition unit 322 is the first classification information. Specifically, the processing unit 323 generates the first electronic receipt data 3111 based on the receipt data, and stores the generated data in the first file 311. The processing unit 323 also has a function of processing the receipt data received by the receiving unit 321 as the receipt data of the non-transaction receipt if the classification information acquired by the acquisition unit 322 is the second classification information. Specifically, the processing unit 323 generates the second electronic receipt data 3121 based on the receipt data, and stores the generated data in the second file 312.

The collection unit 324 has a function of collecting electronic receipt data, which is requested from the information terminal 50 of the user to be downloaded, from the first file 311 or the second file 312. The collection unit 324 searches the first file 311 using the member ID included in a collection request command from the information terminal 50. The collection unit 324 collects the first electronic receipt data 3111 including the member ID from the first file 311. The collection unit 324 also searches the second file 312 using the same member ID. The collection unit 324 collects the second electronic receipt data 3121 including the member ID from the second file 312.

The editing unit 325 has a function of editing an image for viewing an electronic receipt in the information terminal 50 based on the electronic receipt data collected by the collection unit 324 and transmitting the edited image to the information terminal 50 of a download request source.

The provision unit 326 has a function of providing the information terminal 50 of the request source with an image of an electronic receipt requested to be viewed from the information terminal 50 of the user. For example, if viewing of the transaction receipt is requested from the information terminal 50 of the user, the provision unit 326 transmits the transaction receipt data db of the first electronic receipt data 3111 related to the transaction receipt to the information terminal of the view request source. For example, if the view of the non-transaction receipt is requested from the information terminal 50 of the user, the provision unit 326 transmits the non-transaction receipt data Dd of the second electronic receipt data 3121 related to the non-transaction receipt to the information terminal of the view request source.

### <Explanation of Operation of POS Terminal 20>

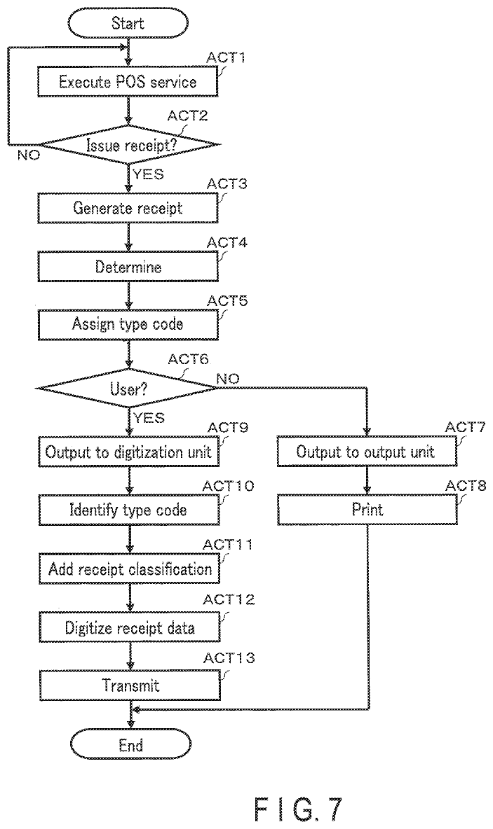

FIG. 7 is a flowchart showing a procedure of main information processing executed by the processor 201 of the POS terminal 20 according to the control program. The processor 201 executes a POS service as ACT 1 by the function of the POS service processing unit 220. Then, the processor 201 stands by for an issuance timing of a receipt as ACT 2. For example, if the settlement service 221 for a commercial transaction is being executed, the processor 201 stands by for an issuance timing of a transaction receipt. For example, if the reload service 222 for electronic money is being executed, the processor 201 stands by for an issuance timing of a reload receipt. For example, if the commercial product purchase reservation service 223 is being executed, the processor 201 stands by for an issuance timing of a reservation receipt.

At an issuance timing of a receipt, the processor 201 determines YES in ACT 2 and proceeds to ACT 3. The processor 201 generates receipt data by the function of the receipt generation unit 230 as ACT 3. For example, if the receipt at the issuance timing is a transaction receipt, the processor 201 generates receipt data of the transaction receipt. For example, if the receipt at the issuance timing is a reload receipt, the processor 201 generates receipt data of the reload receipt. For example, if the receipt at the issuance timing is a reservation receipt, the processor 201 generates receipt data of the reservation receipt.

Upon generation of the receipt data, the processor 201 determines the type of the receipt as ACT 4. Then, the processor 201 assigns a type code corresponding to the type to the receipt data as ACT 5. For example, if the data of a transaction receipt is generated, the processor 201 sets the type code “0”. For example, if the data of a reload receipt is generated, the processor 201 generates the type code “1”. For example, if the data of a reservation receipt is generated, the processor 201 generates a type code “2”.

The processor 201 checks as ACT 6 whether or not the receipt is a receipt issued to a user of the electronic receipt service by the function of the determination unit 242. The processor 201 checks whether or not data for requesting an electronic receipt is input by the function of the input unit 241. If data for requesting an electronic receipt is not input, the receipt for which receipt data is generated in ACT 3 is a receipt to be issued to a consumer other than the user. In this case, the processor 201 determines NO in ACT 6, and proceeds to ACT 7. The processor 201 outputs as ACT 7 the receipt data to the output unit 244 by the function of the switching unit 243. The processor 201 outputs the receipt data to the printer 209 by the function of the output unit 244, and instructs printing as ACT 8.

In this way, in the POS terminal 20, the printer 209 operates and the receipt data is printed on a receipt paper sheet. As a result, a transaction receipt, a reload receipt, a reservation receipt, or the like in a paper medium is issued.

On the other hand, if data for requesting an electronic receipt is input, the receipt for which the receipt data is generated in ACT 3 is a receipt to be issued to a user of the electronic receipt service. In this case, the processor 201 determines YES in ACT 6, and proceeds to ACT 9. The processor 201 outputs as ACT 9 the receipt data to the digitization unit 245 by the function of the switching unit 243.

The processor 201 executes the function of the digitization unit 245 as ACT 10 to ACT 12. That is, the processor 201 identifies as ACT 10 the type code assigned to the receipt data. The processor 201 adds as ACT 11 the receipt classification identified by the type code to the receipt data. Specifically, the processor 201 adds the first classification information, for example, “10”, to the receipt data of the type code “0”, namely, the receipt data of the transaction receipt. The processor 201 adds the reload classification information of the second classification information, for example, “11”, to the receipt data of the type code “1”, namely, the receipt data of the reload receipt. The processor 201 adds the reservation classification information of the second classification information, for example, “12”, to the receipt data of the type code “2”, namely, the receipt data of the reservation receipt. The processor 201 digitizes as ACT 12 the receipt data to which the receipt classification is added.

The processor 201 transmits as ACT 13 the digitized receipt data to the center server 30 by the function of the communication unit 246. Accordingly, the digitized receipt data is transmitted from the communication interface 205 to the center server 30 via the communication network 40.

In this manner, according to the POS terminal 20 of the electronic receipt system 10, it is possible to digitize not only the transaction receipt but also the non-transaction receipt such as the reload receipt and the reservation receipt and to transmit the non-transaction receipt to the center server 30 by each of the functions of the receipt processing unit 240.

<Explanation of Operation of Center Server when Receiving Electronic Receipt>

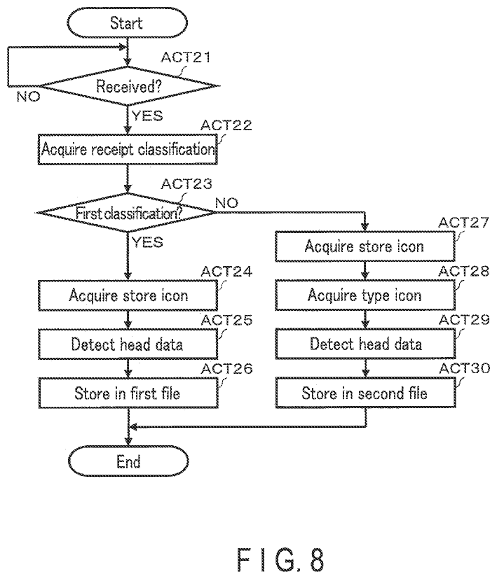

FIG. 8 is a flowchart showing a procedure of main information processing executed by the processor 301 of the center server 30 according to the control program. The processor 301 stands by as ACT 21 for receiving receipt data by the function of the receiving unit 321. Upon receipt of the receipt data transmitted from the POS terminal 20 of any one of the member stores S via the communication interface 305, the processor 301 determines YES in ACT 21 and proceeds to ACT 22. The processor 301 acquires as ACT 22 the receipt classification added to the receipt data by the function of the acquisition unit 322. The processor 301 executes the function of the processing unit 323 as ACT 23 to ACT 30.

That is, the processor 301 checks as ACT 23 whether or not the receipt classification is the first classification information indicating the transaction receipt. If the receipt classification is the first classification information, the processor 301 determines YES in ACT 23 and proceeds to ACT 24. The processor 301 acquires as ACT 24 the store icon set in association with the store code included in the receipt data. The center server 30 includes an icon table in which a unique store icon is set in association with the store code of each member store S. The icon table may be included in another server that can be accessed by the center server 30.

The processor 301 detects as ACT 25 data of an item constituting the index Da of the first electronic receipt data 3111 from the receipt data. Then, as ACT 26, the processor 301 generates the first electronic receipt data 3111 including the index data Da and the transaction receipt data db and stores the generated data in the first file 311.

On the other hand, if the receipt classification is the second classification information, the processor 301 determines NO in ACT 23 and proceeds to ACT 27. The processor 301 acquires as ACT 27 the store icon set in association with the store code included in the receipt data. Further, the processor 301 acquires as ACT 28 the type icon set in association with the receipt classification included in the receipt data. The center server 30 includes an icon table in which a unique type icon such as a reload icon, a reservation icon, or the like is set in association with receipt classification such as reload classification information, reservation classification information, or the like. The icon table may be included in another server that can be accessed by the center server 30.

The processor 301 detects as ACT 29 data of an item constituting the index Dc of the second electronic receipt data 3121 from the receipt data. Then, as ACT 30, the processor 301 generates the second electronic receipt data 3121 including the index data Dc and the non-transaction receipt data Dd and stores the generated data in the second file 312.

Then, the processor 301 ends the information processing when the receipt data is received from the POS terminal 20.

As described above, the center server 30 can store not only the first electronic receipt data 3111 related to the transaction receipt transmitted from the POS terminal 20 of each member store S but also the second electronic receipt data 3121 related to the non-transaction receipt such as the reload receipt, the reservation receipt, or the like. In addition, the center server 30 stores the first electronic receipt data 3111 in the first file 311 and stores the second electronic receipt data 3121 in the second file 312. Therefore, the center server 30 can distinctively store the first electronic receipt data 3111 related to the transaction receipt and the second electronic receipt data 3121 related to the non-transaction receipt. As a result, for example, by analyzing the electronic receipt data stored in the second file 312, it is possible to easily analyze what kind of receipt is digitized as the non-transaction receipt.

<Explanation of Operation of Center Server when Receiving Electronic Receipt Request>

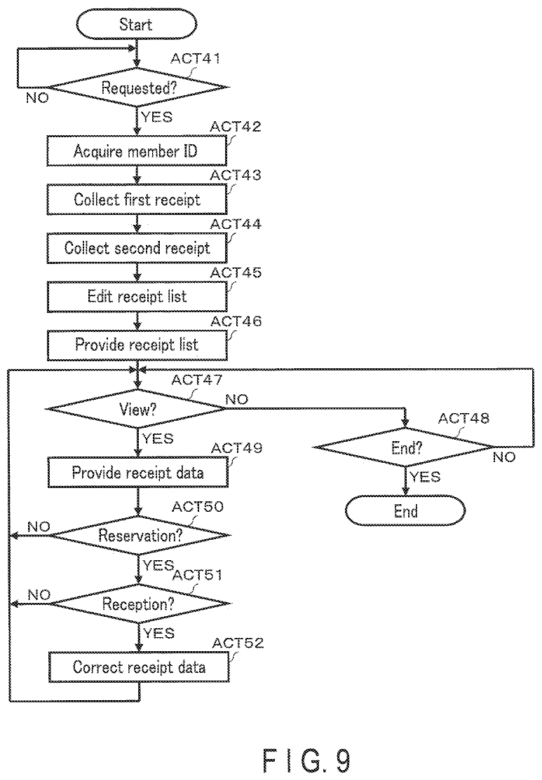

FIG. 9 is a flowchart showing a procedure of main information processing executed by the processor 301 of the center server 30 according to the control program. The processor 301 stands by for a request command for an electronic receipt as ACT 41. The request command for an electronic receipt is wirelessly transmitted from the information terminal 50 to the center server 30 when the user activates a dedicated application program installed on the information terminal 50 and performs an electronic receipt request operation on a home screen of the information terminal 50.

Upon receipt of the request command for the electronic receipt transmitted from the information terminal 50 of the user via the communication interface 305, the processor 301 determines YES in ACT 41 and proceeds to ACT 42. The processor 301 executes the function of the collection unit 324 as ACT 42 to ACT 45.

That is, the processor 301 acquires the member ID of the user from the request command as ACT 42. The processor 301 searches the first file 311 as ACT 43 and collects the first electronic receipt data 3111 including the member ID. Further, the processor 301 searches the second file 312 as ACT 44 and collects the second electronic receipt data 3121 including the member ID.

The processor 301 executes the function of the editing unit 325 as ACT 45. That is, the processor 301 edits a receipt list image based on the collected first electronic receipt data 3111 and second electronic receipt data 3121. The receipt list image will be described later.

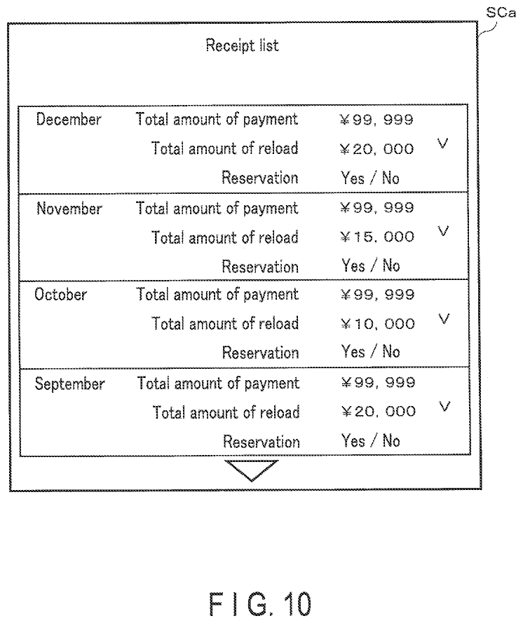

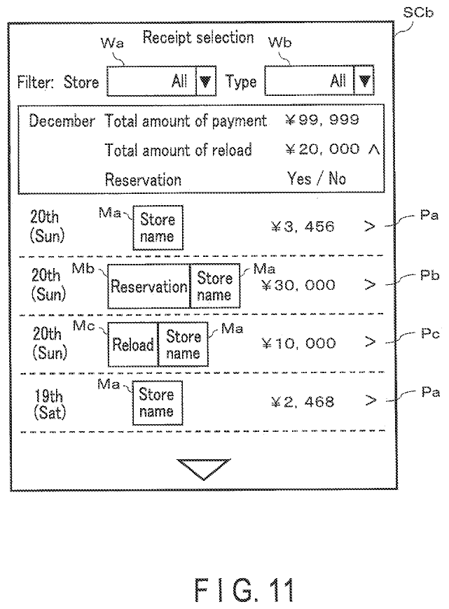

As ACT 46, the processor 301 controls the communication interface 305 to transmit data of the receipt list image by the function of the provision unit 326 to the information terminal 50 that is a request command transmission source. By this control, the data of the receipt list image is transferred through the communication network 40, and is wirelessly transmitted from the access point 60 to the information terminal 50 that is the request command transmission source. As a result, in the information terminal 50, a top screen SCa (see FIG. 10) of the receipt list image is displayed on a display device such as a touch panel.

FIG. 10 is an example of the top screen SCa. As shown in the figure, the total amount of payment, the total amount of reload, and information on a presence or absence of a reservation are displayed on the top screen SCa on a monthly basis. The total amount of payment is a sum of total amounts of transactions included in the first electronic receipt data 3111 with respect to the issue dates in the same month. The total amount of reload is a sum of the reload amounts included in the second electronic receipt data 3121, of which the receipt classification is the classification of the reload receipt, among the second electronic receipt data 3121 with respect to the issue dates in the same month. The information on a presence or absence of a reservation is indicated as “Yes” if the second electronic receipt data 3121 of which the receipt classification is the classification of the reservation receipt is present among the second electronic receipt data 3121 with respect to the issue dates in the same month, and if not, the information is indicated as “No”.

Therefore, the user can know the total amount of payment or the total amount of reload on a monthly basis from the information on the top screen SCa. In addition, the user can know whether or not there is a commercial product reserved in the month.

The user who checks the top screen SCa selects a month for which electronic receipts are to be checked. Then, the receipt list image is switched from the top screen SCa to the receipt selection screen SCb.

FIG. 11 is an example of the receipt selection screen SCb if December is selected on the top screen SCa. As shown in the figure, a list of index images Pa, Pb, and Pc of the electronic receipts issued in December is displayed on the receipt selection screen SCb together with the total amount of payment, the total amount of reload, and the information on a presence or absence of a reservation in December.

The index image Pa is an image based on the index data Da of the first electronic receipt data 3111. The index image Pa is an image representing an issue date, a store icon Ma, and a transaction total amount. The index image Pb is an image based on the index data Dc of the second electronic receipt data 3121 related to the reservation receipt. The index image Pb is an image representing an issue date, a reservation icon Mb, the store icon Ma, and an amount for the corresponding type (the amount of the reserved commercial product). The index image Pc is an image based on the index data Dc of the second electronic receipt data 3121 related to the reload receipt. The index image Pc is an image representing an issue date, a reload icon Mc, the store icon Ma, and an amount for the corresponding type (reload amount).

Therefore, the user can know when and from which store the electronic receipt of the selected month was issued based on the information of the receipt selection screen SCb, while distinguishing the transaction receipt and the non-transaction receipt. In addition, it is possible to identify whether the non-transaction receipt is a reload receipt or a reservation receipt. Further, the reload amount can be easily known from the index image Pc of the reload receipt.

The information included in the index images Pa, Pb, and Pc is not limited to the information indicated in FIG. 11. Any information that allows the user to identify the electronic receipt may be used.

In the receipt selection screen SCb, the index images Pa, Pb, and Pc of electronic receipts issued from the same store can be narrowed down by selecting the store name from a pull-down menu Wa. In the receipt selection screen SCb, the index image Pa, Pb, or Pc of the same type of electronic receipts can be narrowed down by selecting the type of receipt from a pull-down menu Wb.

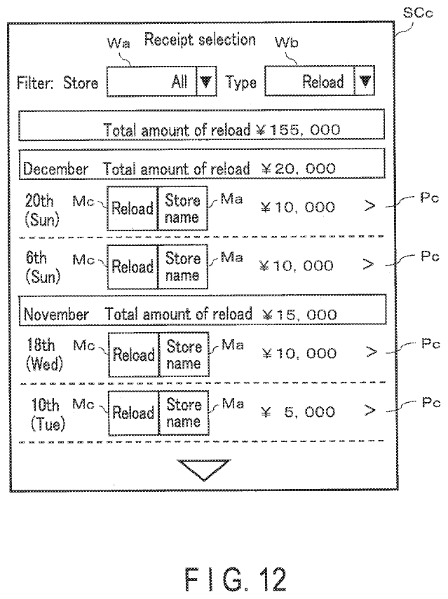

FIG. 12 is a receipt selection screen SCc if the reload receipt is selected from the pull-down menu Wb. As shown in the figure, the total amount of reload, the monthly total amount of reload, and the index images Pc of the monthly reload receipts are displayed on the receipt selection screen SCc. The total amount of reload is, for example, a sum of the reload amounts for one year.

Therefore, from the information of the receipt selection screen SCc, the user can easily know detailed information on when, at which store, and how much the user reloaded in addition to the sum of the reload amounts and the monthly sum of the reload amounts.

Explanations will return to FIG. 9.

The processor 301 of the center server 30 that transmitted the receipt list image checks as ACT 47 whether or not a viewing command was received. If a viewing command was not received, the processor 301 determines NO in ACT 47 and proceeds to ACT 48. The processor 301 checks as ACT 48 whether or not an end command was received. If the end command was not received, the processor 301 determines NO in ACT 48 and returns to ACT 47. In this way, the processor 301 stands by to receive a viewing command or an end command as ACT 47 and ACT 48.

The user who checked the receipt selection screen SCb or the receipt selection screen SCc selects the index image Pa, Pb, or Pc for which the user wants to view the electronic receipt. Then, a viewing command is transmitted from the information terminal 50 to the center server 30. The viewing command includes information of the index images Pa, Pb, or Pc selected by the user.

Upon receipt of the viewing command, the processor 301 determines YES in ACT 47 and proceeds to ACT 49. The processor 301 provides receipt data by the function of the provision unit 326 as ACT 49.

Specifically, the processor 301 specifies the first electronic receipt data 3111 or the second electronic receipt data 3121 from the information of the index image included in the request command. If the first electronic receipt data 3111 is specified, the processor 301 transmits the transaction receipt data db included in the first electronic receipt data 3111 to the information terminal 50 which is the transmission source of the request command. If the second electronic receipt data 3121 is specified, the processor 301 transmits the non-transaction receipt data Dd included in the second electronic receipt data 3121 to the information terminal 50 which is the transmission source of the request command.

The processor 301 that provided the receipt data checks as ACT 50 whether or not the receipt data is data of a reservation receipt. If it is not data of a reservation receipt, the processor 301 determines NO in ACT 50 and returns to ACT 47. That is, the processor 301 returns to the standby state for a viewing command and an end command.

If the receipt data provided to the information terminal 50 is data of a reservation receipt, the processor 301 determines YES in ACT 50 and proceeds to ACT 51. The processor 301 checks as ACT 51 whether or not reception of a reserved commercial product is designated. If the reception of the reserved commercial product is not designated, the processor 301 determines NO in ACT 51 and returns to ACT 47. That is, the processor 301 returns to the standby state for a viewing command and an end command.

If the reception of the reserved commercial product is designated, the processor 301 determines YES in ACT 51 and proceeds to ACT 52. The processor 301, as ACT 52, corrects the non-transaction receipt data Dd of the reservation receipt to the non-transaction receipt data indicating that the commercial product was received. Thereafter, the processor 301 returns to the standby state for a viewing command and an end command.

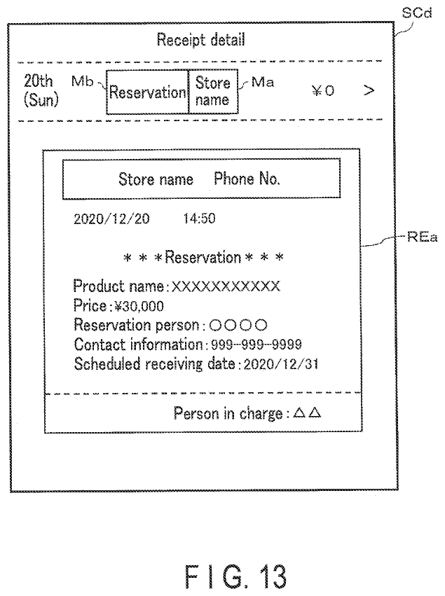

FIG. 13 shows an example of a receipt detail screen SCd displayed on the display device of the information terminal 50 that received the non-transaction receipt data Dd of a reservation receipt REa. The reservation receipt REa displayed on the receipt detail screen SCd can be used as a voucher for the reserved commercial product.

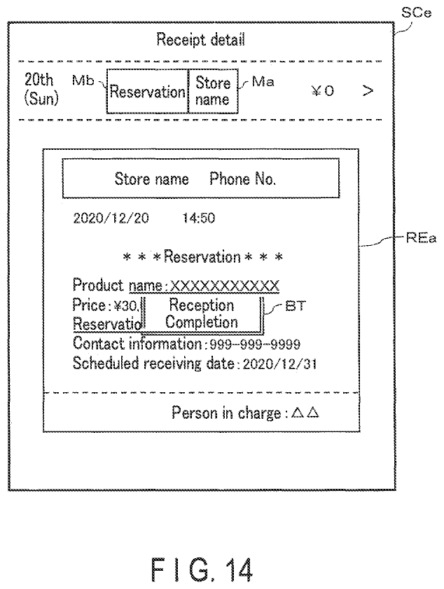

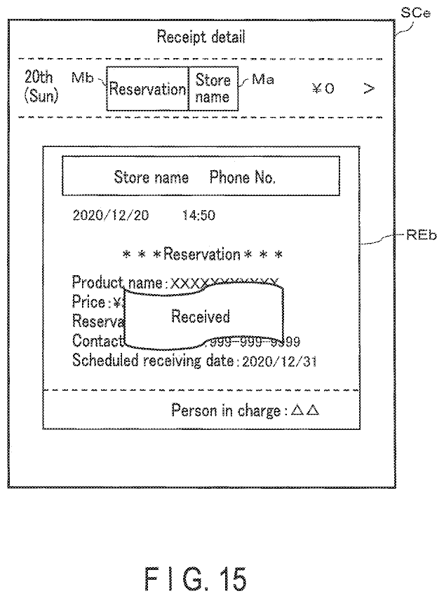

Specifically, the user who reserved the commercial product goes, on the reception date, to the store where the reservation was made, and shows the reservation receipt REa displayed on the information terminal 50 to a salesperson at the store. The salesperson or the user touches the reservation receipt REa. Then, as shown in FIG. 14, a reception completion button BT is displayed on the reservation receipt REa, and the salesperson or the user inputs the reception completion button BT. Then, reception completion of the reserved commercial product is reported from the information terminal 50 to the center server 30. As a result, the non-transaction receipt data Dd of the reservation receipt REa is corrected to the non-transaction receipt data indicating that the commercial product was received. Then, as shown in FIG. 15, a reservation receipt REb indicating that the reserved commercial product was received is displayed on the display device of the information terminal 50.

In this way, the digitized reservation receipt REa can be used as a receipt for the reserved commercial product.

Upon completion of the application program in the information terminal 50, an end command is transmitted. Upon receipt of the end command, the processor 301 of the center server 30 in the standby state for a viewing command and an end command determines YES in ACT 48. The processor 301 ends the information processing of the procedure shown in the flowchart of FIG. 9.

As described above in detail, according to the POS terminal 20 having the function as the receipt processing unit 240, it is possible to digitize not only the transaction receipt but also the non-transaction receipt.

Furthermore, according to the POS terminal 20, it is only possible to digitize the non-transaction receipt if the user of the electronic receipt service presents the member ID. In other words, a consumer who also wants to receive a non-transaction receipt such as a reload receipt or a reservation receipt as an electronic receipt is motivated to actively use the electronic receipt service. Therefore, it is possible to promote the spread of the electronic receipt service.

In addition, if the reservation receipt is digitized, the reservation receipt can be used as a receipt. Therefore, on the part of the store, it is possible to simplify the process of issuing a receipt to the reservation person separately from the reservation receipt. On the part of the reservation person, it is unnecessary to keep the receipt until the commercial product is received.

### <Modification>

The functions of the POS terminal 20 are not limited to the functions as the POS service processing unit 220, the receipt generation unit 230, and the receipt processing unit 240. The receipt generation unit 230 may be included in the function of the POS service processing unit 220. Alternatively, the receipt generation unit 230 may be included in the function of the receipt processing unit 240.

The function of the receipt processing unit 240 may be provided in an information processing apparatus connected to the POS terminal 20. That is, the receipt processing device may be realized by an information processing device separate from the POS terminal.

The receipt processing unit 240 may have the function of the determination unit 242, the function of the digitization unit 245, and the function of the communication unit 246. In other words, the receipt processing device may digitize all transaction receipts or non-transaction receipts generated by the receipt generation unit 230.

The second classification information may be in common regardless of the type of non-transaction receipt. In that case, the same type icon is displayed on the receipt selection screens SCb and SCc of the receipt list image. Even in such an embodiment, it is still possible to digitize the non-transaction receipt.

The data for requesting an electronic receipt is not limited to a member ID of the electronic receipt service. For example, if a point service is carried out in combination with an electronic receipt service, a member ID of a point card and a member ID of an electronic receipt service are linked. This allows the member ID of the point card to be used as data for requesting an electronic receipt.

For example, the type icon is added to the index data Da of the first electronic receipt data 3111. Accordingly, the center server 30 can store the first electronic receipt data 3111 and the second electronic receipt data 3121 in one data file.

The non-transaction receipt is not limited to the reload receipt and the reservation receipt. For example, a receipt as a warranty certificate issued at the time of purchasing a home electric appliance may be digitized. In that case, since the warranty certificate can be digitized and managed by the center server 30, there is no possibility that the certificate may be lost.

The images shown in FIGS. 10 to 15 are merely examples. As long as the user can obtain similar information, the images are not particularly limited to specific contents.

The program concerning the present embodiment may be transferred in a state of being stored in an electronic device or in a state of not being stored in an electronic device. In the latter case, the program may be transferred via a network or may be transferred in a state of being stored in a recording medium. The recording medium is a non-transitory tangible medium. The recording medium is a computer-readable medium. The recording medium may be of any type, such as a CD-ROM or a memory card, as long as it can store programs and can be read by the computer.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such embodiments or modifications as would fall within the scope and spirit of the invention.

1. A receipt processing device comprising:
a POS service processing unit configured to process multiple services;
a receipt generation unit configured to generate the receipt data related to the services processed by the POS service processing unit;
a determination unit configured to determine whether receipt data generated by the receipt generation unit is receipt data of a transaction receipt indicating contents of a commercial transaction or receipt data of a non-transaction receipt indicating contents of a non-commercial transaction;
a digitization unit configured to, digitize, if the receipt data is receipt data of the transaction receipt, the receipt data with an addition of first classification information, and digitize, if the receipt data is receipt data of the non-transaction receipt, the receipt data with an addition of second classification information different from the first classification information; and
a transmission unit configured to transmit the receipt data digitized by the digitization unit to a server.

2. The receipt processing device according to claim 1, further comprising:
an input unit configured to input data for requesting an electronic receipt;
an output unit configured to output receipt data to a printing device; and
a switching unit configured to supply, if data for requesting the electronic receipt is input through the input unit with respect to the receipt data generated by the receipt generation unit, the receipt data determined by the determination unit to the digitization unit, and supply, if data for requesting the electronic receipt is not input, the receipt data determined by the determination unit to the output unit.

3. The receipt processing device according to claim 1, wherein the non-transaction receipt is a reload receipt for recording reload information of electronic money or a reservation receipt for recording reservation contents of a commercial product.

4. An electronic receipt system comprising:
the receipt processing device according to claim 1;
a receiving unit configured to receive the receipt data digitized by the receipt processing device;
an acquisition unit configured to acquire classification information added to the receipt data received by the receiving unit; and
a processing unit configured to process, if the classification information acquired by the acquisition unit is the first classification information, the receipt data as receipt data of the transaction receipt, and process, if the classification information acquired by the acquisition unit is the second classification information, the receipt data as receipt data of the non-transaction receipt.

5. The electronic receipt system according to claim 4, wherein the server further comprises a provision unit configured to provide a terminal of a receipt request source with the receipt data processed as receipt data of the transaction receipt or the non-transaction receipt in the processing unit.

6. A receipt processing method comprising:
processing multiple services;
generating receipt data related to the services;
determining whether the receipt data generated by the receipt generation unit is receipt data of a transaction receipt indicating contents of a commercial transaction or receipt data of a non-transaction receipt indicating contents of a non-commercial transaction;
digitizing, if the receipt data is receipt data of the transaction receipt, the receipt data with an addition of first classification information, and digitizing, if the receipt data is receipt data of the non-transaction receipt, the receipt data with an addition of second classification information different from the first classification information; and
transmitting the digitized receipt data to a server.

7. A non-transitory computer-readable medium storing a control program for causing a computer of a receipt processing device configured to process receipt data generated by a receipt generation unit to realize:
a function of processing multiple services;
a function of generating receipt data related to the services;
a function of determining whether the receipt data is receipt data of a transaction receipt indicating contents of a commercial transaction or receipt data of a non-transaction receipt indicating contents of a non-commercial transaction;
a function of digitizing, if the receipt data is receipt data of the transaction receipt, the receipt data with an addition of first classification information and digitizing, if the receipt data is receipt data of the non-transaction receipt, the receipt data with an addition of second classification information different from the first classification information; and
a function of transmitting the digitized receipt data to a server.
